(19) United States
(12) Patent Application Publication
(10) Pub. No.: US 2005/0177930 A1
(43) Pub. Date: Aug. 18, 2005

(54) Roofer hip pad

(76) Inventor: Ronald Ray Kitchen, Independence, MO (US)

Correspondence Address: RONALD RAY KITCHEN, 10602 EAST 20 STREET, INDEPENDENCE, MO, 64052, US

(21) Appl. No.: 11/049,122

(22) Filed: Feb. 3, 2005

Related U.S. Application Data
(60) Provisional application No. 60/544,922, filed on Feb. 17, 2004.

(51) Int. Cl. A62B 17/00; G21F 3/02; A41D 13/06

(52) U.S. Cl. 2/455

(57) ABSTRACT

This unit was designed for the purpose of assisting shingle roofers to sit more securely and comfortably. It is made from nylon and polymer material sewn with nylon thread. It has two belt loops for inserting utility belts. The upper loop is for taller workers, and the lower loop is for shorter workers. It has two second plies of nylon and polymer material sewn on the front of the unit, one for upper leg strap and one for lower leg strap to be inserted. The purpose of this is, in the event that a leg strap becomes stretched out or breaks, a new leg strap can be inserted. This unit comes with a replaceable foam rubber pad contoured to fit around the leg. The pad has loop material secured in contour with adhesive. This loop material enables the pad to be secured to the unit.

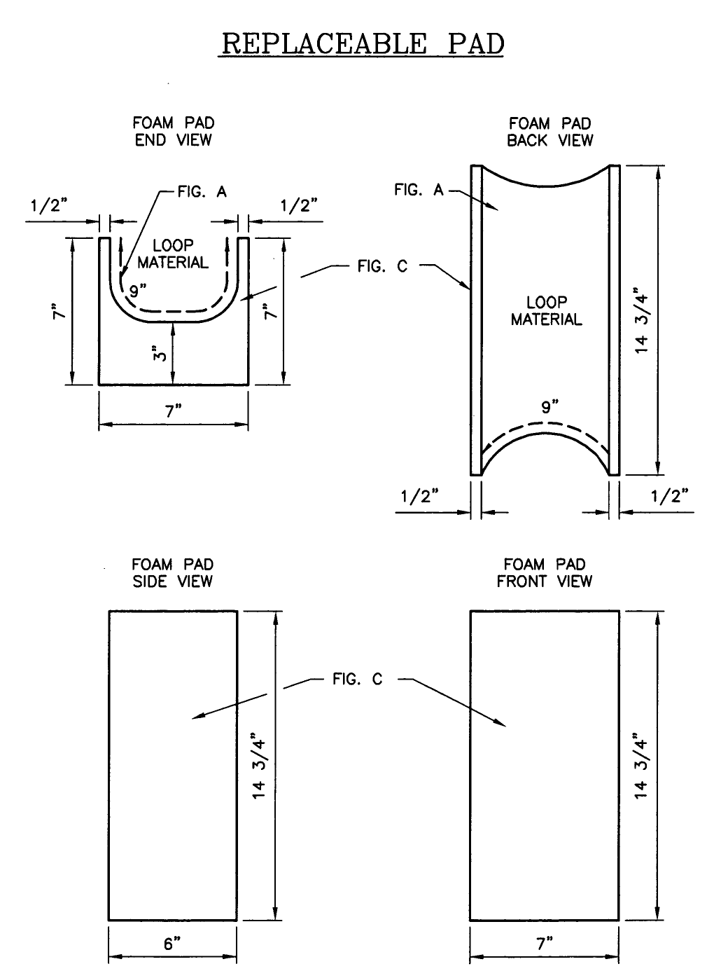

FIG. 1 is front view of unit and indicated dimensions.

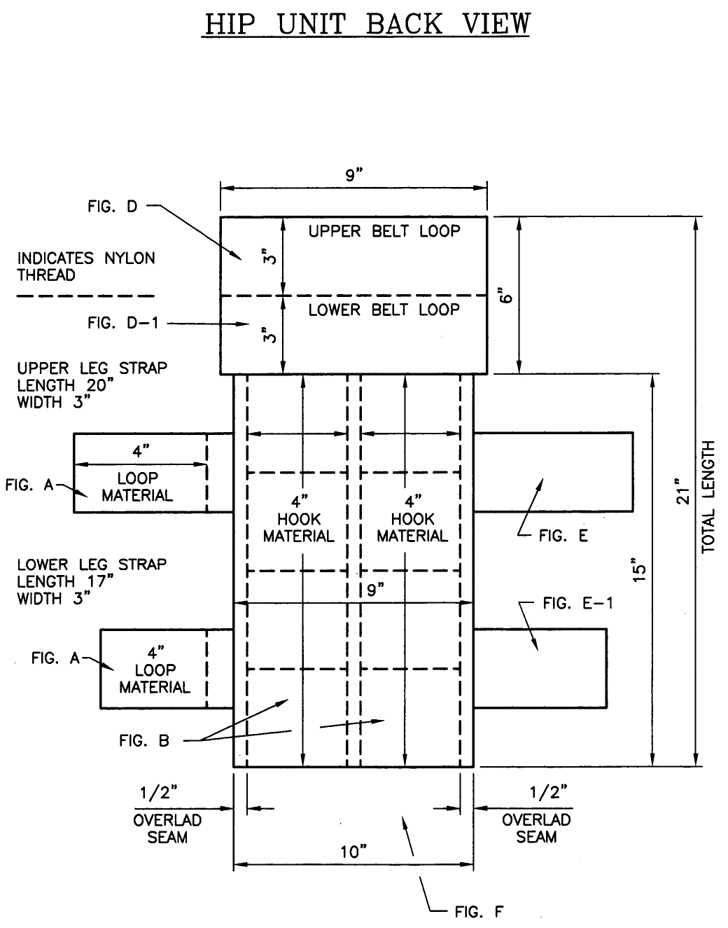

FIG. 2 is back view of unit and indicated dimensions.

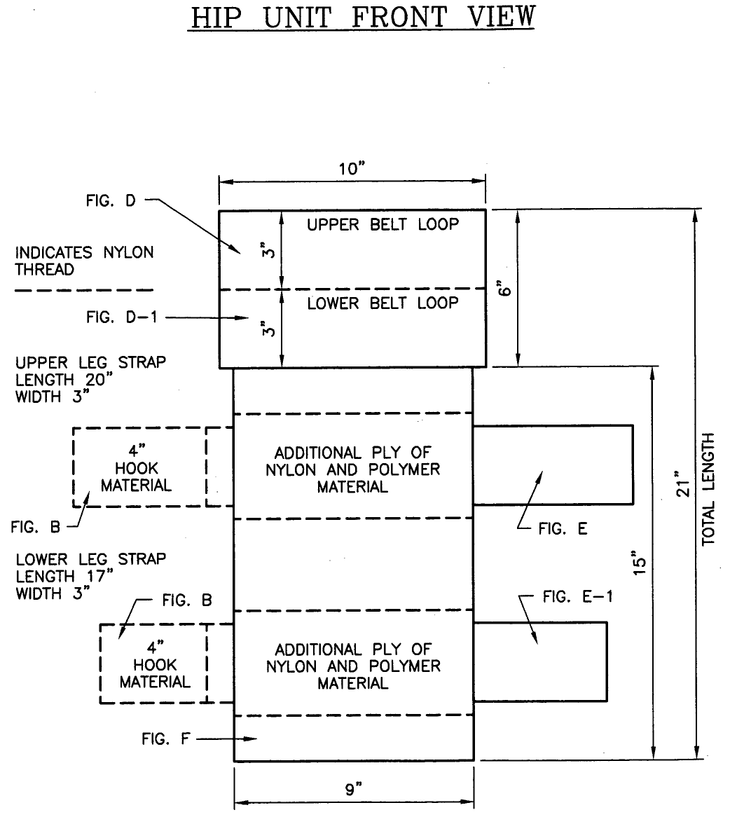

FIG. 3 is end view, back view, side view, and front view of replaceable pad and indicated dimensions.

### BRIEF SUMMARY

The design and dimension of this invention were slightly altered. Elastic material at top of unit was replaced with belt loops and lower calf unit was eliminated. The width of unit was shortened by one inch. Overall length remains the same. Replacement pad was contoured for better fit, and thickness of measurements was changed for more comfort.

1. An apparatus for supporting roofers comprised of a hip unit and a foam rubber hip pad designed to attach together forming a complete unit.
